(19) United States
(12) Patent Application Publication
(10) Pub. No.: US 2022/0222374 A1
(43) Pub. Date: Jul. 14, 2022

(54) DATA PROTECTION

(71) Applicant: Sensyne Health Group Limited, Oxford (GB)

(72) Inventors: Anna Antoniou, Oxford (GB); Paula Petrone, Oxford (GB); Steve Hamblin, Oxford (GB)

(73) Assignee: Sensyne Health Group Limited, Oxford (GB)

(21) Appl. No.: 17/607,572

(22) PCT Filed: Apr. 30, 2020
(86) PCT No.: PCT/GB2020/051052

§ 371 Date: Oct. 29, 2021

(30) Foreign Application Priority Data
Apr. 30, 2019 (GB) 1906086.2

(51) Int. Cl. G06F 21/62; G06F 21/57

(52) U.S. Cl. CPC G06F 21/6254; G06F 2221/034; G06F 21/577

(57) ABSTRACT

Disclosed herein is a computer-implemented method for simulating a data security attack in respect of a specified k-anonymised database derived by a k-anonymisation process using a k-block array having an index representative of equivalence class sizes and populated with elements representative of respective numbers of each said equivalence class size in said k-anonymised database, said k-anonymised database comprising a plurality of subject records, subsets of said subject records being associated with respective subjects and each subject record comprising data representative of a respective subject characteristic.

This invention relates generally to data protection and the anonymization of data, such as Electronic Health Records (EHRs), and, more particularly, to an apparatus and method that utilise the probability of re-identification of subjects within a data set, as a result of a malicious attack, to define the parameters of an anonymization process so as to meet a required threshold for the probability that subjects will be identified.

Various organisations, such as hospitals, collect and integrate vast amounts of subject data during the course of their normal activities and store them as a database of subject records. Such records are intended for future reference by the organisation that collected the data. However, it is well established, in some sectors at least, that such records could provide opportunities for other organisations to leverage the collected data for research purposes. For example, the digitalization of hospital data in the form of Electronic Health Records (EHRs), collected and integrated over time during normal clinical care, serves the primary purpose of improving healthcare quality. However, in view of the great potential for knowledge-discovery such records offer, it is increasingly common for them to be used for biomedical research and it has been shown that cohort-wide data mining of EHR databases has multiple benefits as valuable biomedical insights can be derived from real-world evidence as opposed to those available from clinical trials using controlled populations, for example. Table 1 below is a representative dataset comprising an excerpt from a (fictitious) EHR database to be anonymised.

TABLE 1

| Patient NHS number | Gender | Age | Postcode | Ethnicity | LOS | Diagnosis |
|---|---|---|---|---|---|---|
| 123 456 7890 | M | 50 | OX12 6HU | White | 2 | Cancer |
| 123 456 7890 | M | 50 | OX12 6HU | White | 6 | Pneumonia |
| 111 342 9807 | M | 53 | OX12 9HU | White | 3 | Cancer |
| 111 342 9807 | M | 53 | OX12 9HU | White | 11 | Stroke |
| 878 452 0908 | M | 55 | OX12 8JU | White | 4 | Pneumonia |
| 878 452 0908 | M | 55 | OX12 8JU | White | 7 | Flu |
| 878 452 0908 | M | 55 | OX12 8JU | White | 16 | Pneumonia |
| 673 542 8745 | F | 64 | OX14 6GU | Mixed | 22 | Cancer |
| 879 543 8132 | F | 65 | OX14 7GU | Mixed | 24 | Cancer |
| 763 356 4625 | F | 65 | OX14 8GU | Mixed | 27 | Cancer |
| 989 323 3221 | F | 58 | OX13 6AB | Mixed | 4 | Flu |
| 837 473 7584 | F | 62 | OX13 6AF | Mixed | 2 | Flu |
| 878 462 9834 | F | 60 | OX13 6BX | Mixed | 3 | Ulcer |

However, leveraging confidential data for research purposes comes with the responsibility to protect subject confidentiality. Therefore, harnessing the knowledge-discovery potential of EHR databases requires, both legally and ethically, the implementation of strict patient confidentiality and data security and protection procedures and this is one of the main challenges facing EHR custodians, as it requires close collaboration between policy makers, industry, regulatory bodies and hospitals in order to ensure high quality data collection under strict rules of confidentiality. As a result, data anonymization is an emerging field of critical importance, and various data anonymisation techniques have been developed, all offering increasing levels of security at the cost of performance and loss of data.

Anonymised data may be subject to re-identification attacks which aim to identify individual subjects using external datasets, i.e. by using a leaked subset of the original data set and other external information or prior knowledge to link the records and gain access to the sensitive information about individual subjects. Therefore, anonymisation techniques rely on minimising the probability of re-identification of individual or multiple subjects as a result of a ‘leak’ of a subset of the original data into malicious hands. Some precedents for releasing anonymised data to highly trusted recipients exist, which set a maximum threshold for re-identification of a single subject. It is thus important to put in place secure anonymization techniques for such sensitive data, that enable the likelihood of re-identification of individual subjects to be characterised. Accordingly, there is a critical need to be able to determine the risk of a data security breach of this type in respect of a specified anonymised dataset and, indeed, a need to be able to set or select anonymization parameters to meet a predetermined level or degree of data security, but also to allow as much valuable knowledge as possible to be retained in the anonymised dataset for the intended purpose.

K-anonymisation is a known and widely-used privacy-preserving algorithm used to anonymise EHR databases prior to release to protect against identity attacks, see, for example, L.Sweeney, k-anonymity: A model for protecting privacy, International Journal of Uncertainty, Fuzziness and Knowledge-Based Systems 10 (05) (2002) 557-570. It relies on grouping similar EHRs into equivalence classes composed of k members such that they are indistinguishable from each other. Datasets of the type illustrated above in Table 1 typically comprise three kinds of data attributes: direct identifiers, quasi-identifiers and sensitive attributes. Any information that directly identifies individuals on a one-to-one mapping (e.g. national insurance number) is called a direct patient identifier. Attributes not directly capable of identifying a patient, but able to do so when used in combination with other patient attributes or publicly available data, are called quasi-identifiers. These include patient demographics (gender, age, postcode, ethnicity, and some diagnosis codes). Finally, sensitive attributes include all health information and diagnoses. However, some diagnoses might be more sensitive than others if more prone to stigma (e.g. HIV status, substance abuse, mental health or data on minors) and the degree of sensitivity needs to be taken into consideration when determining a re-identification threshold.

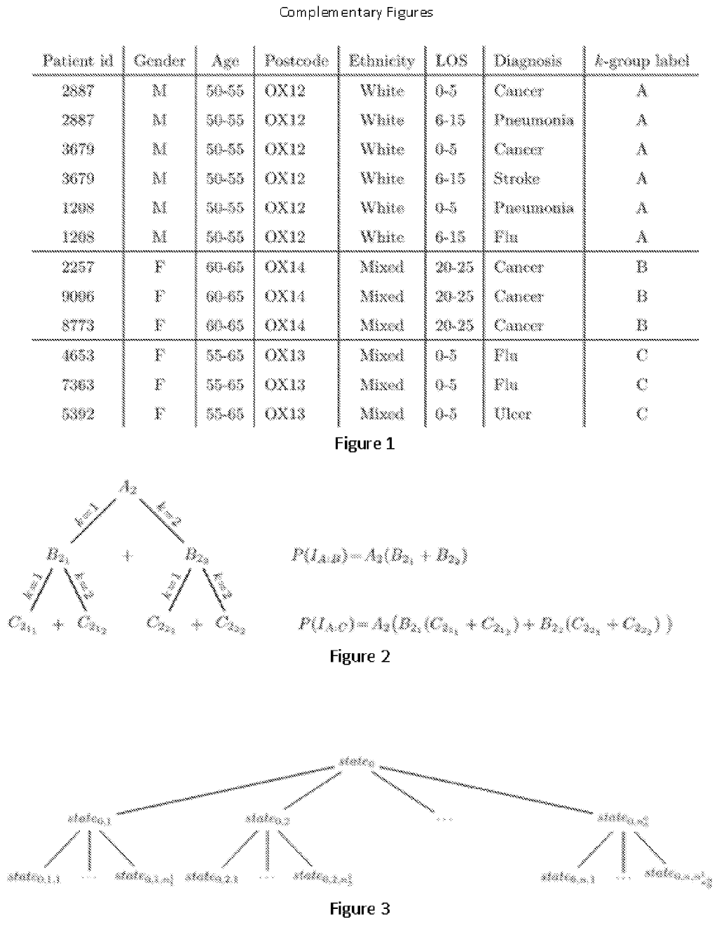

K-anonymisation is based on a series of generalisations and suppressions of quasi-identifiers such that a group of at least k subjects are indistinguishable. Integer k can be considered to be the minimum number of members within a group. In more detail, given a positive integer k, an algorithm will generalise the quasi-identifiers and group subjects in (at least) k members sharing the same quasi-identifiers such that they are indistinguishable. Thus, for example, subject age may be generalised into age ranges and subjects then grouped according to their age, such that subject age is essentially ‘lost’ or suppressed from the resultant dataset. The groups, thus created, are said to form equivalence classes. Referring to FIG. 1 of the drawings, for example, it can be seen that the equivalence classes are obtained by generalising the age, postcode, ethnicity and LOS (length of stay) data from Table 1. Each resulting equivalence class contains three patients, wherein, in one of the equivalence classes A, each patient has two records (LOS range and diagnosis), and in each of the other two equivalence classes B, C, each patient has one record (diagnosis). As a result of k-anonymisation, some records may be outliers (i.e. not fit into any equivalence class) and they are also suppressed by the algorithm. In a k-anonymization process, all direct identifiers are suppressed and can be replaced by a unique and randomised number ensuring that the translation from the direct identifier to the new patient ID is irreversible. Admissions belonging to a given patient will still be associated to a unique randomised patient ID.

Whilst k-anonymisation is becoming the most common type of anonymization technique used in respect of EHR databases, k-anonymised datasets are not exempt of data security attacks that aim to reidentify subjects to utilise their confidential information for malicious pourposes. During a re-identification attack, an adversary having access to some public external data (e.g. Table 2 below) and a target dataset (Table 1) will attempt to link the two to gain new information. As a very simple example, although John Doe does not appear in the target dataset (Table 1), if the adversary knows that John Doe has visited the specific hospital and is, as a result, present in the dataset, the values of gender, age, postcode and ethnicity can be matched, they can determine that John Doe was hospitalised for cancer and pneumonia, thereby carrying out a successful re-identification attack. In general, the more quasi-identifiers known to an adversary, the more likely it is that the re-identification attack will be successful.

TABLE 2

| Name | Gender | Age | Postcode | Ethnicity |
|---|---|---|---|---|
| John Doe | M | 50 | 0X12 6HU | White |

The prevalence of social media forums such as rare disease sufferers support groups, databases and health discussion boards provides a new stream of external datasets of unfiltered and unmonitored patient information that can be utilised by an adversary and become a threat to anonymised data which could lead to multiple re-identifications using a single leaked dataset.

There is currently no practical means to determine a risk of a data security attack or characterise a risk of subject re-identification arising under a hypothetical linkage attack in respect of a k-anonymised database. Indeed, this is especially technically complex where the number of subjects represented in each equivalence class size within a k-anonymised dataset is not the same, and where the attacker may only have access to a subset of a k-anonymised dataset. An object of one aspect of the invention is to provide a means for assessing the risk of a deliberate data security attack resulting in an adversary re-identifying a portion of a k-anonymised dataset. A unique analytical solution to quantify the exact probability of re-identification of a single member in a k-anonymised dataset is proposed, and a technical problem sought to be addressed by at least aspects of the present invention is how to determine the risk of a successful data security attack, in the event of a defined data leak, by characterising the risk of re-identification of a single subject or multiple subjects simultaneously (as a result of the same data leak). Clearly, this will depend on the size of the leaked anonymised dataset, which needs to be defined in order to define the maximum number of subjects that could, in theory, be re-identified therefrom. It is a highly technical problem to provide a method of, effectively, simulating the effects of a linkage attack in respect of a k-anonymised database, that is able to quantify the risk of re-identification of multiple subjects, given a leaked anonymised dataset of a specified size, and which, in turn, could also be used to adjust the parameters of a k-anonymisation process in order to meet a predefined risk threshold.

Aspects of the present invention seek to address at least some of these issues and, in accordance with a first aspect of the present invention, there is provided a computer-implemented method for simulating a data security attack in respect of a specified k-anonymised database derived by a k-anonymisation process using a k-block array having an index representative of equivalence class sizes and populated with elements representative of respective numbers of each said equivalence class size in said k-anonymised database, said k-anonymised database comprising a plurality of subject records, subsets of said subject records being associated with respective subjects and each subject record comprising data representative of a respective subject characteristic, the method comprising:
receiving, as inputs, data representative of the size (D) of said specified database, the size (L) of a hypothetical data leak in respect of said k-anonymised database, and a hypothetical number (n) of subjects to be re-identified by said data security attack;
calculating a total probability P(I_{1 to n}) that n subjects are re-identified from a said data leak by:
for each of a plurality (k) of equivalence class sizes associated with said k-anonymisation:
   determining a first term comprising a probability that a first subject A is in said leak;
   determining a second term comprising a probability that said first subject A is in said respective equivalence class;
   utilising said first and second terms to, for each j other subject in said respective equivalence class, where j ranges from 0 to k_{A}−1:
      determine a probability that said j other subjects are in said data leak;
         calculate a probability of re-identification of a respective subject given that said subject j and j−1 other subjects are also in said data leak; and
         remove said respective subject j from said dataset and data leak and recursively re-identify the next subject;
and
outputting the total probability, or risk, of such a data attack representative of the likelihood of said data security attack.

Thus, this first aspect of the invention provides a method, in relation to a k-anonymised database, of simulating a data security attack in the form of re-identification of one or more subjects as a result of a defined data leak by using a unique recursive method for calculating the total probability of re-identification of multiple subjects, given a leak of a specified size (which may not be the entire k-anonymised dataset), which takes into account, with each iteration of the calculation, the fact the subject of the current iteration may or may not be in the current equivalence class and the subject of the previous iteration may or may not have been in the current equivalence class. By taking these issues into consideration in the calculation, the resultant probability calculation precise and enables a highly accurate data security attack simulation to be effected. An exact solution to the calculation of this probability has not previously been proposed, and the present invention is unique in enabling this form of data security assessment. An additional technical benefit of the invention is that the unique probability calculation can be performed using a small number of coding steps and a relatively small processing and storage capacity, such that it can be readily implemented in a real-world system, on any computing device, to provide results in a realistic time frame.

Thus, in accordance with another aspect of the present invention, there is provided a computer-implemented apparatus for use in verifying and/or designing a k-anonymised database, the apparatus being configured to simulate a data security attack in respect of a specified k-anonymised database derived by a k-anonymisation process using a k-block array having an index representative of equivalence class sizes and populated with elements representative of respective numbers of each said equivalence class size in said k-anonymised database, said k-anonymised database comprising a plurality of subject records, subsets of said subject records being associated with respective subjects and each subject record comprising data representative of a respective subject characteristic, the apparatus comprising:
an interface for receiving, as inputs, data representative of the size (D) of said specified database, the size (L) of a hypothetical data leak in respect of said k-anonymised database, and a hypothetical number (n) of subjects to be re-identified by said data security attack;
a risk assessment module comprising a processor for receiving said inputs and calculating a total probability P(I_{1 to n}) that n subjects are re-identified from a said data leak by:
for each of a plurality of equivalence class sizes k associated with said k-anonymisation:
   determining a first term comprising a probability that a first subject A is in said leak;
   determining a second term comprising a probability that said subject A is in said respective equivalence class k_{A};
   utilising said first and second terms to, for each j other subject in said respective equivalence class, where j ranges from 0 to k_{A}−1:
      determine a probability that said j other subjects are in said data leak;
         calculate a probability of re-identification of a respective subject given that said subject and j−1 other subjects are also in said data leak; and
         remove said respective subject from said dataset and data leak and recursively re-identify the next subject;
and
outputting, via said interface, a risk value, equal to the said total probability, representative of the likelihood of said data security attack; such that the risk value can be assessed against a predetermined risk threshold to verify said k-anonymised database or enable parameters of said k-anonymisation process to be changed in order to generate a new k-anonymised database having a desired risk threshold.
In an embodiment, the size of said database may comprise a number (D) of subjects to which said subject records relate. The size of the data leak may comprise a number of leaked subject records (L). In a preferred exemplary embodiment, the total probability P(I_{1 to n}) that a subject (A) is re-identified from a said leak may be calculated by, recursively for each subject and for each of a plurality of equivalence class sizes associated with said k-anonymisation, using an algorithm characterised as,

$$term 1 \times term 2 \times \frac{term 3 \times term 4}{term 5} \times term 6$$

wherein term1 represents a probability of re-identifying said respective subject A and j other subjects in a respective equivalence class in said leak,
term2 corresponds to said first term,
term3 represents the total number of ways the remaining spaces in the leaked data set can be chosen given that A and j other subjects are in the leaked data set,
term4 represents the total number of ways the leaked data set can be filled given that A is already part of the leaked data set,
term5 represents a total number leaked subject records after the removal of said respective subject A and the other j equivalent subjects from the respective equivalence class,
(note: the ratio involving terms 3-5 calculate the total probability of the state from which the calculations of terms 1 and 2 can be assumed, i.e. the probability that j subjects are also in the leaked data set), and
term6 corresponds to said second term.

$$Optionally \text{:} term 1 = \frac{1}{j + 1} ; term 2 = \frac{L}{D} ;$$

$$\frac{term 3 * term 4}{term 5} = \frac{( \begin{matrix}k - 1 \\ j\end{matrix} ) ( \begin{matrix}D - k \\ L - ( j + 1 )\end{matrix} )}{( \begin{matrix}D - 1 \\ L - 1\end{matrix} )} ;$$

$$term 6 = \frac{number of subjects in k \text{-} blocks of size k}{total number of subjects}$$

In accordance with another aspect of the present invention, there is provided a computer-implemented method for generating a k-anonymised database characterised by a k-block array having an index representative of equivalence class sizes and populated with elements representative of respective numbers of each said equivalence class size, the method comprising:

performing a first k-anonymisation process using first k-anonymisation parameters in respect of an original database to generate a first k-anonymised database characterised by a first minimum equivalence class size;

using a method substantially as described above to simulate a data security attack in respect of said first k-anonymised database to determine an associated risk value;

comparing said risk value with a predetermined risk threshold and, if said risk value is greater than said predetermined risk threshold, performing a second k-anonymisation process, using second set of k-anonymisation parameters, in respect of said original database to generate a second k-anonymised database characterised by a second minimum equivalence class size greater than said first minimum equivalence class size.

The larger the equivalence class size, the greater the reduction in the risk of re-identification, but there is a trade-off between that and the resultant loss of information. It is therefore desirable to use a minimum class size that optimises the retention of valuable information against the risk of re-identification.

In this case, the optimal selection of minimum equivalence class or k-block size for use in a subsequent k-anonymisation process is a key technical feature, in that it takes into account (once again) the idea that the leaked dataset may not be a complete k-anonymised dataset, multiple re-identifications need to be considered, and the varying equivalence class sizes and number (within the bounds set by the minimum equivalence class size) enable the anonymisation process to be optimised to the extent that a required risk threshold can be met whilst retaining as much of the valuable knowledge from the original dataset as possible. The method described above can be performed iteratively in order to determine the optimum minimum k-block size to meet a predetermined risk threshold. Alternatively, multiple instances of the risk determination can be performed substantially simultaneously, for respective multiple minimum equivalence class sizes, and the minimum equivalence class size selected from the multiple outputs to most closely match the acceptable risk. Such multiple results may be output in graphical form so as to display the effect on the risk value for different values of minimum equivalence class size. For example, respective risk values may be output and displayed graphically with respect to the hypothetical number n of subjects to be re-identified.
In any or all of the above-described aspects, the original database may be an Electronic Health Record (EHR) database, said subjects may be patients, and said subject records may comprise personal and health information pertaining to respective said patients and collected over time.
In accordance with a further aspect of the present invention, there is provided a computer implemented method of generating, for a biomedical research activity, a k-anonymised database derived from an Electronic Health Record database acquired by a healthcare provider comprising a plurality of clinical files associated with a respective plurality of patients, each clinical file comprising a plurality of records pertaining to a respective patient, the method comprising:
selecting or generating a maximum risk threshold comprising or associated with a maximum total probability P(I_{1 to n}) that a patient (A) is re-identified from a predefined data leak in respect of a said k-anonymised database;
defining a first minimum equivalence class size;
performing a first k-anonymisation process in respect of said Electronic Health Record database to derive a first k-anonymised database characterised by a first k-block array having an array index representative of a plurality of equivalence class sizes equal to or greater than said first minimum equivalence class size;
using a method substantially as described above to simulate a data security attack in respect of said first k-anonymised database to obtain a first risk value associated with said first k-anonymised database;
comparing said first risk value with a predetermined risk value and, if said first risk value is greater than said predetermined risk threshold, selecting a second minimum equivalence class size greater than said first minimum equivalence class size, and performing a second k-anonymisation process in respect of said Electronic Health Record database to derive a second k-anonymised database characterised by a second k-block array having an array index representative of a plurality of equivalence class sizes equal to or less than said second minimum equivalence class size.

These and other aspects of the invention will be apparent from the following detailed description, in which:

FIG. 1 is a schematic diagram illustrating the result of a simplistic k-anonymisation process performed in respect of the dataset of Table 1;

FIG. 2 is a schematic illustration of a recursive tree representative of the process of re-identification of patients used in a method according to an exemplary embodiment of the present invention, wherein k=2;

FIG. 3 is a schematic illustration of a recursive tree representative of a method of calculating the probability of re-identification three patients from a leaked k-anonymised dataset;

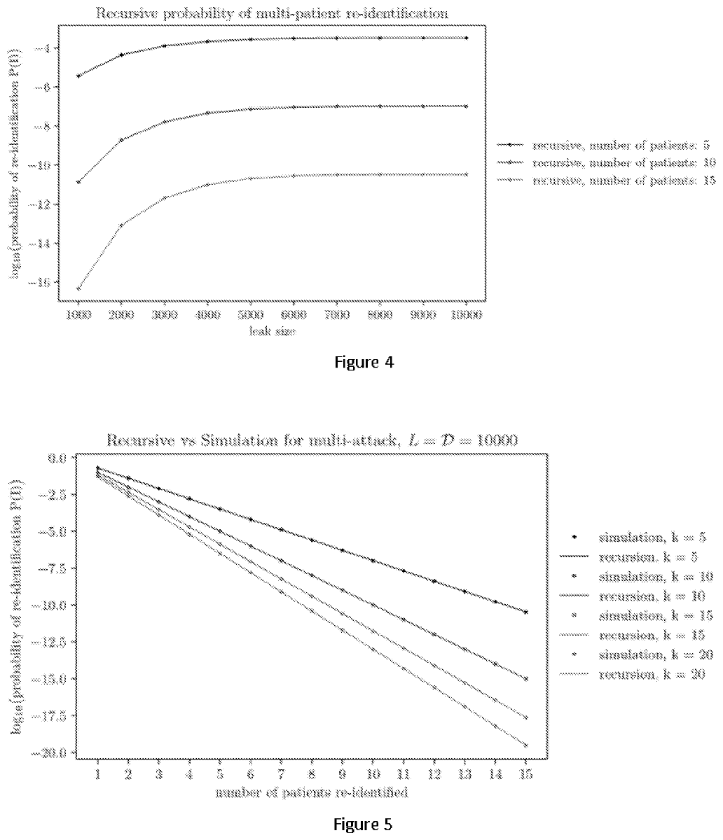

FIG. 4 is a graphical illustration of the probability (log scale) of re-identification of patients against the number of patients to be re-identified from a leaked k-anonymised dataset, wherein L=D=10000 and the minimum equivalence class size k=5,10,15 and 20;

FIG. 5 is a graphical representation of a recursive solution to the probability (log scale) of re-identification of multiple patients from a leaked k-anonymised dataset, wherein L varies from 1000 to 10000 in steps of 1000 and n=5,10 and 15;

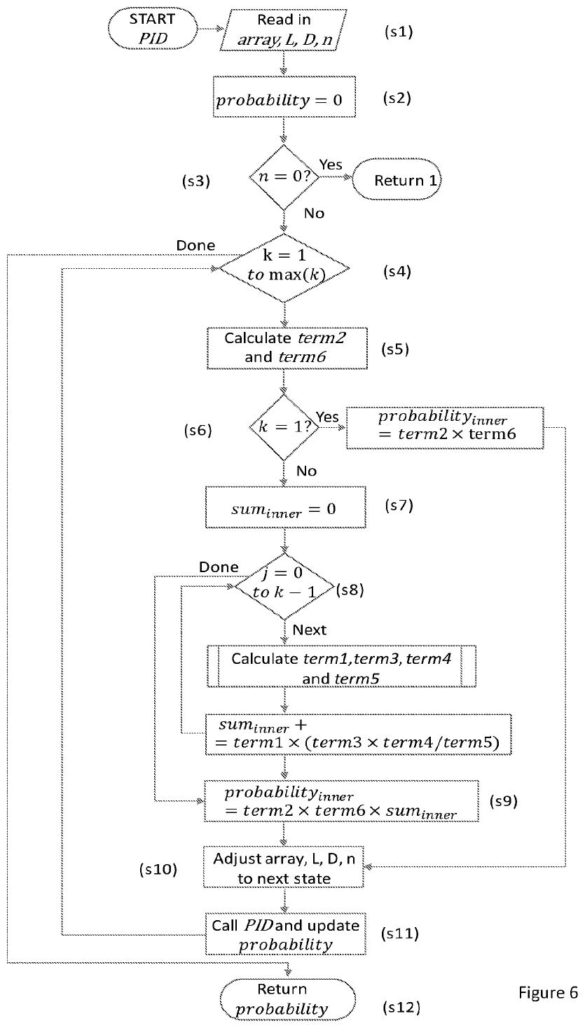

FIG. 6 is a schematic flow diagram illustrating principal features of a simulation method according to an exemplary embodiment of the present invention;

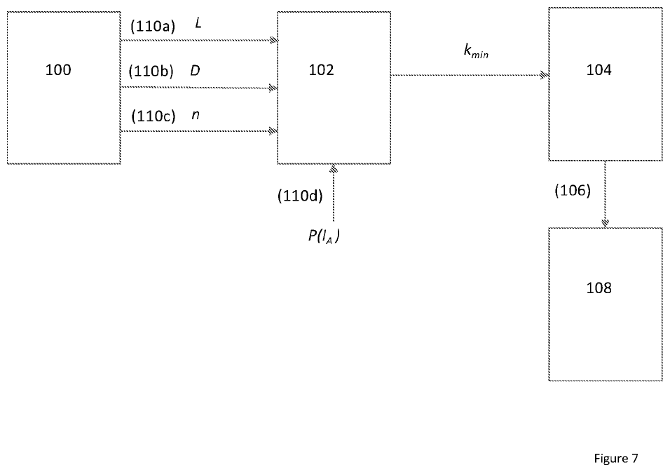

FIG. 7 is a schematic block diagram illustrating principal features of a system according to an exemplary embodiment of the invention; and

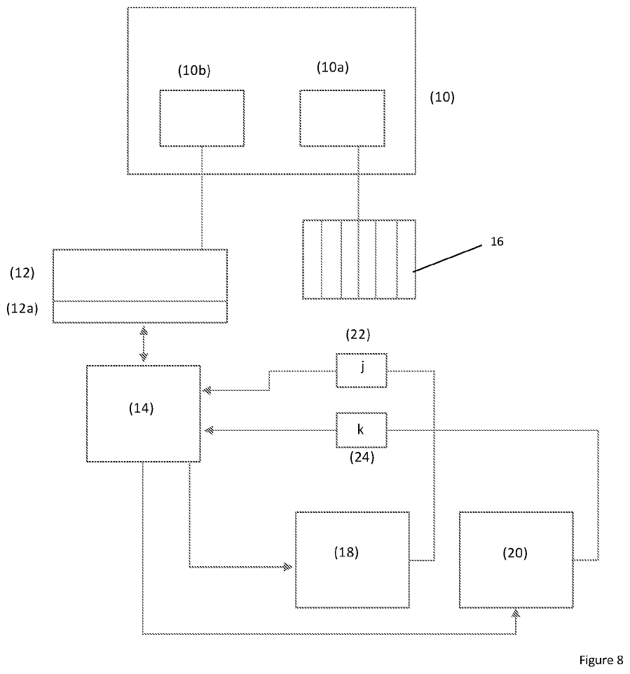

FIG. 8 is a schematic block diagram illustrating a computer-implemented simulation apparatus according to an exemplary embodiment of the present invention.

An exemplary embodiment of the present invention facilitates the accurate characterization of a risk of a data security attack using an accurate estimation of the probability of a single or multi-patient linkage attack arising from a data leak of any specified size (i.e. all or a specified proportion of an anonymised dataset) in respect of an EHR database. This, in turn, can improve data security in released anonymised data by enabling the parameterization of a k-anonymisation process. In other words, the k-anonymised database can be designed and/or re-designed by setting appropriate bounds on an equivalence class array, given a realistic leak size and an acceptable probability of re-identification, so as to ensure subject confidentiality to an acceptable degree whilst retaining as much information within the anonymised dataset as possible. An equivalence class array k defines the number of each equivalence class (k-block) size characterising a specified k-anonymised database. For example, an equivalence class array [0, 10, 4] denotes 0 equivalence classes of 0 subjects, 10 equivalence classes (or k-blocks) of 1 subject and 4 equivalence classes of 2 subjects. In the following, we denote by X an arbitrary patient who is the target of a re-identification attack within the anonymised dataset of size D. Patient X's medical history consists of a series of records each corresponding to a hospital admission.

In accordance with an embodiment of the invention, a given re-identification attack can be completely characterized by the following parameters:
the size D of the dataset D,
the size L of a leaked dataset L c D,
the equivalence class b^{D} in D to which X belongs,
its size |b^{D}|=k,
the equivalence class b^{L} ⊆b^{D} in L to which X belongs,
its size |b^{L}|=h.

For an accurate determination of a re-identification risk value, the following list of events can be considered or simulated within the respective sample space:
Eᵢ^{D}: event in which subject X belongs to the equivalence class bᵢ^{D},
Eᵢ^{L}: event in which subject X belongs to the equivalence class bᵢ^{L} ⊆ bᵢ^{D} in the leaked dataset L,
E_{i,h}^{L}: event in which the equivalence class bᵢ^{L} ⊆ bᵢ^{D} has size h,
Eₗ: event in which the subject X is re-identified by the adversary.

The events Eₗ^{D} ∩ Eₗ^{L} ∩ E_{l,h}^{L} and Eⱼ^{D} ∩ Eⱼ^{L} ∩ E_{j,h}^{L} are disjoint when i≠j, and the pairs of events Eᵢ^{D}, Eⱼ^{D} and Eᵢ^{L}, Eⱼ^{L} respectively are disjoint ∀ i≠j. Finally, E_{i,h}^{L} and E_{i,h}^{L}, are mutually exclusive whenever h≠h′ since, given a leak, the size of the i^{th} equivalence class in the leaked dataset can only have one value. P(Eₗ) can then be written as a sum of probabilities, as follows:

$$P ( {E}_{I} ) = {\sum }_{i = 1}^{D / k} {\sum }_{h = 1}^{k} P ( {E}_{I} ⋂ {E}_{i}^{L} ⋂ {E}_{i}^{D} ⋂ {E}_{i , h}^{L} ) \qquad ( 1 )$$

where the inner and outer summations span the varying equivalence class sizes in L and the varying equivalence class sizes in D respectively.

By applying equation (1) to the events listed above, we obtain:

$$P ( {E}_{I} ) = \frac{D}{k} {\sum }_{h = 1}^{k} \frac{1}{h} \times \frac{h}{k} \times \frac{k}{D} \times \frac{( \begin{matrix}k \\ h\end{matrix} ) ( \begin{matrix}D - k \\ L - h\end{matrix} )}{( \begin{matrix}D \\ L\end{matrix} )} = \frac{1}{k} {\sum }_{h = 1}^{k} \frac{( \begin{matrix}k \\ h\end{matrix} ) ( \begin{matrix}D - k \\ L - h\end{matrix} )}{( \begin{matrix}D \\ L\end{matrix} )} \qquad ( 2 )$$

Thus, equation (2) provides a technical basis for accurately determining the probability of re-identifying X given a number of assumptions, and is a relatively simplistic and analytical calculation. In reality, it is required to enable the probability of multiple re-identifications to be accurately determined, in order to determine a realistic risk and with a view to determining a realistic risk of a data security attack.

Thus, in accordance with aspects of the present invention, the above-described solution for the probability of single re-identification is first extended to a more realistic and complex case, i.e. the re-identification of multiple individuals in one attack. However, the method proposed herein goes beyond the simple assumption that all equivalence classes are the same size, to provide a technically useful general scenario in which there is a given distribution of equivalence class sizes which is more realistic for standard anonymisation procedures and afford an opportunity to optimise such procedures such that the probability of single or multiple subject re-identification can be limited to a predefined threshold whilst allowing an maximum amount of data/knowledge to be preserved from the original dataset. This is a technically complex problem which, if it is to be implemented in a real-world system, needs to be solved with a realistic processing and storage overhead. The present inventors have, therefore, tackled this complex problem by means of a recursive re-identification method that can be achieved within realistic timescales in an ordinary computer.

Consider the problem of calculating the probability that three subjects (A, B, C) are re-identified P(I_{A}, I_{B}, I_{c}) from a k-anonymised dataset with a maximum equivalence class size K. The initial state of the system can be described by three parameters:
n the number of subjects being re-identified (in the probability calculation);
D the size of the dataset (i.e. the number of subjects records)
L the size of the leaked dataset
[{b^{D}: k=1}, . . . , |{b^{D}: k=K}|]: an array where each index I holds the number of equivalent classes of size I in D

The probability of re-identifying the first subject A depends on which equivalence class size they come from and how many other subjects j ∈ {1, . . . k−1} from the same equivalence class are also in the leaked dataset, such that:

$$P ( {I}_{A} ) = {\sum }_{k = min \vert {b}^{D} \vert}^{K} {\sum }_{j = 0}^{k - 1} P ( {E}_{k}^{j} ) \qquad ( 3 )$$

The resultant recursive tree can be visualised as the ‘recursive tree’ illustrated in FIG. 2 of the drawings.

For the general case where the equivalence class sizes k in D are k={1, . . . , K}, the probability of re-identification of A consists of the following events:

$$k = 1 \text{:} {E}_{1}^{0} \\ k = 2 \text{:} {E}_{2}^{0} , {E}_{2}^{1} \\ k = 3 \text{:} {E}_{3}^{0} , {E}_{3}^{1} , {E}_{3}^{2} \\ ⋮ ⋮ ⋮ ⋮ ⋱ \\ k = K \text{:} {E}_{k}^{0} , {E}_{k}^{1} , {E}_{k}^{2} … {E}_{k}^{k - 1} \qquad ( 4 )$$

If it is assumed, for example, that the equivalence class sizes k=2 and we are re-identifying 3 subjects, then the initial state is:

L,D,n=3, and[0,0,|{b^{p}:k=2}|]

and the re-identification probability for the first subject A is:

$$\begin{matrix}P ( {I}_{A} ) = P ( {E}_{2}^{0} ) + P ( {E}_{2}^{1} ) \\ = 1 \times \frac{L}{D} \times \frac{( \begin{matrix}1 \\ 0\end{matrix} ) ( \begin{matrix}D - 2 \\ L - 1\end{matrix} )}{( \begin{matrix}D - 1 \\ L - 1\end{matrix} )} \times \frac{\vert \{ {b}^{D} \text{:} k = 2 \} \vert}{\vert \{ {b}^{D} \text{:} k = 1 \} \vert + \vert \{ {b}^{D} \text{:} k = 2 \} \vert} \\ = \frac{1}{2} \times \frac{L}{D} \times \frac{( \begin{matrix}1 \\ 1\end{matrix} ) ( \begin{matrix}D - 2 \\ L - 1\end{matrix} )}{( \begin{matrix}D - 1 \\ L - 1\end{matrix} )} \times \frac{\vert \{ {b}^{D} \text{:} k = 2 \} \vert}{\vert \{ {b}^{D} \text{:} k = 1 \} \vert + \vert \{ {b}^{D} \text{:} k = 2 \} \vert}\end{matrix} \qquad ( 5 )$$

If we let the probability of re-identification of subject A be A₂ where the subscript denotes the equivalence class size the subject belongs to in D, then the recursive tree of FIG. 2 can be followed to find the probability of re-identifying a second subject B. In FIG. 2, the initial top node denotes the probability A₂ of re-identification of a single subject where the initial state contains only equivalent classes of size 2. Before we re-identify the second subject, we need to update our system array and take into account the event that the second subject might be in an equivalence class size of 2 or 1. The same methodology is followed for re-identifying the third subject. Sibling nodes are added and their summand is multiplied up with their parent node.

Thus, as A has already been re-identified, the remaining leaked dataset will contain one equivalence class of size 1, and one less equivalence class of size 2 and the new updated state is:

$$L - , D - 1 , n = 2 , and [ 0 , 1 , \vert \{ {b}^{D} \text{:} k = 2 \} \vert - 1 ]$$

Subject B could now belong in k=1 or in one of the k=2 equivalence classes. The same calculations can be carried out as set out above, but using the new system state. B₂_{₁} is the probability of re-identification of the second subject given they come from k=1 and the previously re-identified subject originated from k=2. The subscripts denote the history of the subject: the first subscript denotes the equivalence class size of the previously re-identified subject and the second is the equivalence class size that the subject is in. B₂_{₁} and B₂_{₂} are additive and their sum represents the probability of identifying B given A has been re-identified:

$$P ( {I}_{B} \vert {I}_{A} ) = {B}_{{2}_{1}} + {B}_{{2}_{2}} \qquad ( 6 )$$

The probability of identifying both A and B is obtained by multiplying B₂_{₁}+B₂_{₂} with its parent node A₂ such that:

$$P ( {I}_{B} ⋂ {I}_{A} ) = P ( {I}_{A} ) P ( {I}_{B} \vert {I}_{A} ) = {A}_{2} \times ( {B}_{{2}_{1}} + {B}_{{2}_{2}} ) \qquad ( 7 )$$

The same logic is followed for identifying the third subject C. In pseudo code, the probability of re-identifying n subject P(I_{I:n}) is:

def PID (array, L, D, n):
probability=0
for each equivalence class size:
   calculate the probability of re-identifying a subject and multiply that by PID(array_{new}, L−1, D−1, n−1)
add together the results of the loop

The recursive process can be used to derive the exact re-identification probability for a leak in a k-anonymised dataset. At each step, P(I_{A}), the probability that a subject will be re-identified given L,j,k, is defined and calculated as follows:

$$\begin{matrix}P ( {I}_{A} ) = \frac{1}{j + 1} \times \frac{L}{D} \times \frac{( \begin{matrix}k - 1 \\ j\end{matrix} ) ( \begin{matrix}D - 2 \\ L - ( j + 1 )\end{matrix} )}{( \begin{matrix}D - 1 \\ L - 1\end{matrix} )} \times \\ \frac{number of subjects in k \text{-} blocks of size k}{total number of subjects} \\ = term 1 \times term 2 \times \frac{term 3 \times term 4}{term 5} \times term 6\end{matrix} \qquad ( 8 )$$

where:
L is the leak size or number of subjects leaked;
D is the size of the dataset or number of subjects in the dataset
k is the size of k-block/equivalence class
j is the number of other subjects from the same k-block that are also in the leaked dataset. This can range from 0 to k−1;

The meaning of the terms in the second part of equation (11) is as follows:
term1: probability of re-identifying a given subject given said j other equivalent subjects in leaked set;
term2: probability of a given subject being leaked;
   terms 3 to 5 together calculate the probability of selecting j other subjects from the same equivalence class as our person given a leak L, i.e. the probability of the state from which the calculation of terms 1 and 2 are assumed;
term6: probability that our subject is in a k-block of size k;

In the following we present pseudo-code describing how the algorithm could be realised is presented in relation to the main function PID. It describes the recursive function that calls both LogarthmicProduct and ChoosingJfromL to calculate the probability of re-identification of a k-anonymised dataset. It accepts as inputs the number of subjects in the anonymised dataset, the leaked number of subjects, the number of subjects we are re-identifying and an array where the array index is the k-block size and the element residing is the number of k-blocks of size equal to the index. In the following pseudo code, where L, D and n refer to the leaked number of subjects, the total number of subjects in the dataset and the number of subjects to re-identify respectively, we have:

```
def PID(array L, D, n):
  SET probability = 0
  IF n = 0:
    RETURN 1
  ELSE:
    FOR each equivalence class size k:
      SET probabilityᵢₙₙₑᵣ = 0
      calculate term2 and term6
      IF k-block size is 1:
        probabilityᵢₙₙₑᵣ = term2 × term6
      ELSE:
        SET sumᵢₙₙₑᵣ = 0
        FOR each other person in the k-block:
          calculate term1, term3 and term5
          sumᵢₙₙₑᵣ = sumᵢₙₙₑᵣ + term1 × term3 × term4/term5
        probabilityᵢₙₙₑᵣ = term2 × term6 × innerₛᵤₘ
      Make a copy of the array
      Add 1 to array[k−1] an subtract 1 from array[k]
      probability = probability + probabilityᵢₙₙₑᵣ × PID(array, L − 1, D −
1, n − 1)
  RETURN probability
```

LogarithmicProduct (complimentary function 1/2). This function takes as inputs two integers: a start and an end. It then calculates the logarithm of each number starting from the start, and calculates the sum of the logs until it reaches the end. This function is called in ChoosingJfromL (see below).

ChoosingJfromL (complimentary function 2/2). This function receives integers after which it puts them into two arrays of equal length such that one array represents the numerator and the other the denominator terms of equation 11. The arrays are sorted in ascending order. The ith number of the first array is compared with the ith number of the second array, and LogarithmicProduct (as seen above) is called appropriately. The logarithmic sum of each array pair is calculated and its exponent returned. The sorting out of each array and subsequent pairing of each array speeds up the combinatorial calculation by minimising the distance between the start and end in LogarithmicProduct, which is significant in terms of the volume of code required to perform such a huge function when expanded into its individual terms, and optimises processing and storage costs.

This embodiment of the invention comprises a method of simulating a data security attack in respect of a k-anonymised dataset (representing D subjects) by determining a probability of re-identification of one or more subjects (defined by a specified n), given a specified data leak of size L (in terms of the number of leaked records). The k-anonymised dataset comprises selected records relating to the D subjects, these records being arranged in equivalence classes or k-blocks of various sizes (i.e. numbers of subjects), and the number of subjects in each k-block size k (0 to K) can be organised into, or represented by, and array having an index defining the k-block sizes from 0 (or 1) to K and elements representing the respective number of subjects.

Referring to FIG. 6 of the drawings, the method derived above of simulating a data security attack in respect of such a k-anonymised dataset is described in more detail with reference to a process flow chart. In the process described in detail below, the input data is transformed in a uniquely efficient manner, to derive a recursive solution to the calculation of probability of a specified security breach in respect of a given data set and a selected data leak. At step s1, the function PID is initialised with the input values for D, L, n, and the above-referenced array. At step s2, a parameter ‘probability’ is set to zero. This is state₀ of the recursive process. At step s3 a check is performed on the number of people to re-identify n, whereby if there are no more subjects, ends the recursive process. At step s4 the process enters an ‘outer’ iterative loop which is repeated for each k-block size as specified by the array. When complete this step returns the probability of re-identification of all n subjects, given above-referenced input data defining a particular k-anonymised dataset (i.e. with each loop, PID is called recursively until n=0 at step s3). At step s5 term2 and term6 are calculated for each iteration of the outer loop. At steps s5 and s6 a check is carried out and sumᵢₙₙₑᵣ is initialised prior to entering an inner loop at step s8 that calculates sumᵢₙₙₑᵣ, summing the contributions for each ‘other’ subject in the k-block that has leaked. This is done by calling function ChoosingJfromL. At step s9 the probabilityᵢₙₙₑᵣ is calculated, the array, L, D and n are adjusted for the next state (s10), the probability is updated and PID is called again (s11) with the new variables before we move onto the next k-block size (s4). The process is repeated until k=K, and the final updated probability is returned at step s12.

As stated above, the step s9 of calling the function ChoosingJfromL within the function PID is particularly significant in terms of implementation of the method using realistic processing and storage overhead, thus enabling the method to be implemented in a standard computing device to obtain results within an acceptable time frame.

In FIG. 3 of the drawings, the steps of the recursive algorithm are illustrated using a tree. It is helpful, for visualisation purposes, to define the current state of the system state₀ that contains all the variables described above that are used to calculate the re-identification probabilities. Additionally, we can define parameter nₛ^{l} that is the number of distinct k-block sizes in the current state s and tree level I, such that:

n₀⁰ is the number of distinct and non-zero k-block sizes in state₀, i.e. if all
the k-blocks are of size 2, then n₀⁰ = 1
n₁¹ is the number of distinct and non-zero k-block sizes in state_{0, 1}
.
.
.
nₙ_{₀}_{⁰}¹ is the number of distinct and non-zero k-block sizes in state_{0, n}_{₀}_{⁰}

The top node (state₀) denotes the initial state of the system (level 0). This is defined as a state with n₀⁰ distinct number of k-block sizes. The re-identification probability of the first subject is calculated using the parameters belonging to that state. As there are n₀⁰ different k-block sizes in state₀, removing one subject from the system will create n₀⁰ distinct states (state_{0,1}−state_{0,n}_{₀}_{⁰}). That is because the previously re-identified subject could have been a member of any of the n₀⁰ k-block sizes. The re-identification of the second subjects now the expected value of the distinct re-identification probabilities each different state will produce. Each state in level 1 will produce further states found in level 2 of the tree. For example state_{0,1} holds n₁¹ distinct k-block sizes and will thus produce n₁¹ states. Each new level of the tree is used to calculate the probability of re-identification of a new subject given that all the subjects on the above levels have been re-identified. Consequently, the number of levels of the tree will be equal to the number of subjects that are being re-identified.

Referring to FIG. 8 of the drawings, a computer implemented simulation apparatus for use in verifying or designing a secure k-anonymised database is illustrated in the form of hardware elements. However, it will be appreciated that any or all of the elements of the illustrated embodiment could be implemented in a web or cloud based form, and the present invention is not necessarily intended to be limited in this regard. Equally, the connections between the individual elements of the illustrated embodiment are shown as hard wired connections for illustration purposes only, and it will be appreciated that any or all of the connections between individual elements of the apparatus could be wireless or utilise any convenient or suitable wireless communications standard, as required. The illustrated computer-implemented apparatus comprises an interface 10 having an input device 10a and an output device 10b. The input device 10a may, for example, comprise a keyboard or other user input device of a computer or workstation and the output device may comprise a display device and/or a printer or other visual display means. However, in other exemplary embodiments, the output device 10b may be directly connected to k-anonymisation module for enabling automatic verification of a k-anonymised database and/or alteration of a minimum equivalence class size thereof in accordance with a result of the risk value determination.

The illustrated apparatus further comprises a processor 12 having an associated register 12a communicably coupled to a main memory 14 in which the computer code for implementing a data security attack simulation is stored. An input array 16 receives values of L, D, and n from the input device 10a and inputs them to the processor 12. The input array also receives one or more values of equivalence class size k. Thus, it may receive a single value for k defining a minimum equivalence class size, it may receive several different minimum equivalence class sizes, for each of which the risk value determination is to be performed, or it may receive an array (as described above) defining various equivalence class sizes and the numbers of each characterising the k-anonymised database under consideration, depending on the implementation and requirements of the apparatus.

The processor 12 calls each instruction from the main memory 14, according to the current location defined by the register 12a, to perform the method described above with reference to FIG. 6. At each respective stage, the processor outputs a value of sumᵢₙₙₑᵣ to an sumᵢₙₙₑᵣ memory 18 and updates a value of j held in a first unitary array 22, and outputs a value of probabilityᵢₙₙₑᵣ to a probabilityᵢₙₙₑᵣ memory 20 and updates a value of k held in a second unitary array 24. Each new value of j and k is input to the processor 12. The output of the risk determination is sent to the output device 10b and it may be displayed on a screen of the computing device and/or sent to a printer such that the result can be printed. The input array may, for example, contain several values of n or L, and the apparatus may be configured to perform the risk value calculation for each of the different values and output the results graphically. For example, if the input array receives, as inputs, L, D and n=1 to 15 (incremented by 1), and four set values of minimum equivalence class size: k=5, 10, 15 and 20, the graphical results of the risk value determination process can be seen in FIG. 4 of the drawings. Alternatively, if the input array receives several different values of L (up to a maximum of D), and three distinct values of n (5, 10 and 15), the graphical results of the risk value determination process can be seen in FIG. 5 of the drawings.

Thus, the methods and apparatus described above and used in exemplary embodiments of the present invention provide a novel means to robustly quantify the effect of k-anonymisation parameters in relation to a defined number of leaked records on multi-patient re-identification probability under the light of a re-identification attack due to a malicious (anonymised) data leak. This, in turn, can be used within a k-anonymisation system, wherein appropriate bounds can be placed on equivalence class size, given an acceptable re-identification probability, thereby enabling the provision of a k-anonymised dataset that meets some predetermined risk threshold, whilst preserving therein as much data and knowledge from the original dataset as possible. By, not only being able to assess the re-identification risks associated with a k-anonymization process, but also, in some embodiments, enabling the effective parameterization of a k-anonymisation process the k-anonymization process, the adoption of safer anonymisation measures is enabled in an optimum manner, preserving as much original data as possible, thus facilitating the release of real-world data that bears enormous potential to contribute to fields such as biomedical research.

Referring to FIG. 7 of the drawings, a computer-implemented apparatus according to an exemplary embodiment of the present invention comprises an input interface 100, a risk assessment module 102 communicably coupled to a k-anonymisation module 104, the k-anonymisation module 104 having an output 106 coupled to a digital memory 108. The risk assessment module 102 has inputs 110a, 110b, 110c which may be input by (or under control of) a user, via the input interface 100 (or otherwise), the inputs comprising values representative, respectively, of leak size L (or the number of subject records leaked, hypothetically, from an anonymised dataset), the size D of the entire dataset (or the number of subjects referenced in the anonymised dataset), and n (representative of the number of subjects to be re-identified for the purposes of assessing the risk associated with such re-identification). These inputs represent the “user”-defined constraints on the risk calculation. A fourth input 110d represents the user-defined risk threshold required to be attained in respect of a database of subject records. An object of this exemplary embodiment of the present invention is to provide a minimum equivalence class size kₘᵢₙ (in terms of number of members or “subjects”) to meet a predetermined data security risk.

In use, the risk assessment module 102 essentially applies the recursive risk calculation algorithm described above in respect of equation (11) above, and determines a risk associated with a respective k-anonymised database characterised by a k-block array having a minimum k-block size (or multiple such k-anonymised databases each having a different respective minimum k-block size). The lowest value of kₘᵢₙ can be selected that still meets, or most closely matches, a predetermined risk threshold such that the desired degree of security can be achieved whilst retaining as much as possible of the original data in the k-anonymised dataset.

It will be understood that, in this exemplary embodiment, the required probability is user-defined (i.e. ‘known’) so the output of the process will, in fact, be a value for kₘᵢₙ defining a minimum k-block size to meet the required risk threshold. This can be input to the k-anonymisation module 104, which has access to the raw dataset to be anonymised. The k-anonymisation module 104 is configured to perform a (known) k-anonymisation process using this value of kₘᵢₙ and a user input U1, which may comprise selection of one or more characteristics to be utilised in grouping data in the k-anonymisation process. Furthermore, and uniquely, risk identification is made possible calculating the probability of multiple re-identification events as a result of a single (defined) leak, allowing also for the fact that the leak may not comprise the complete k-anonymised dataset but may, instead, be a subset of the anonymised database. The output 106 of the k-anonymisation module 104 is an anonymised dataset which is output to the digital memory 108, and made available for release as required.

The significant technical advances made by the present inventors will be apparent from the foregoing. In prior art k-anonymisation processes, a single minimum number is defined as the bound for determining the maximum equivalence class size for use in k-anonymisation of a dataset. Not only can this result in a severely restricted dataset as a result of an over-abundance of caution on the part of the data protector, but it can also result in many, otherwise valuable, records being suppressed during the k-anonymisation process. Furthermore, prior art methods cannot calculate the probability or risk of single or multiple re-identifications as a result of a single data leak, which can either result in an inadequately k-anonymised dataset being released or, more likely, a k-anonymised dataset being released in which an excess of data has been suppressed in an attempt to safeguard subject confidentiality. Any known methods of assessing risk, which are rough estimates at best, also cannot be extended to take into account the additional factors incorporated into the methods of the invention, and, indeed, the sheer volume of code that would be required to implement any such attempted extension, not to mention the processing and storage costs, would make it impossible to achieve within realistic bounds, if at all. The present invention is unique in that it enables the probability of re-identification to be accurately calculated, taking into account various real-world factors, to provide an optimal way to accurately assess re-identification risk and, in accordance with some exemplary embodiments, actually select or derive a minimum k-block size, when used in a k-anonymisation process, optimises the anonymization such that an appropriate risk threshold is met, whilst retaining as much of the original (valuable) biomedical data as possible. This is achieved, in practical terms, by the use of an algorithm that lends itself to a recursive method, thereby minimising the computer code required to implement it, and optimising processing and storage requirements, thereby enabling the results to be obtained in reasonable timescales.

It will be apparent to a person skilled in the art, from the foregoing description, that modifications and variations can be made to the described embodiment without departing from the scope of the invention as defined by the appended claims. For example, in an alternative exemplary embodiment, the system may provide the user with the ability to set the k-anonymisation parameters and configured to determine the risk of re-identification of one or more subjects for various leak sizes. Then, depending on the probability of each of those leak sizes occurring, the user can then select those k-anonymisation parameters or alter them and repeat the process until an optimum solution is reached. This process could be performed automatically by the system to meet some predetermined risk threshold and/or retain some predetermined degree of knowledge in respect of a specified database. The agile recursive calculation described above allows the whole process to be achieved in realistic timelines, which may be key if the process of achiving a predetermined risk is repeated several times. For example, as part of this process, certain characteristics of the dataset could be selected not to be suppressed during the k-anonymisation process. This function could be useful, or even critical, if the anonymised dataset is required for use in a research program that requires specified data. Thus, a process may be configured to receive in this case, a predetermined risk threshold and data representative of essential subject characteristics (i.e. those not to be suppressed during the anonymization process) and iteratively or simultaneously perform the calculations to provide multiple solutions, from which a kₘᵢₙ can be selected to meet the requirements. In other words, it may operate to calculate the probability of re-identification of n subjects for different leak sizes and, if a predetermined risk threshold cannot be met for any of the leak sizes, alter the value of kₘᵢₙ and repeat the process until the risk threshold can be met, then apply that kₘᵢₙ to the k-anonymisation module 106. It is envisaged that exemplary embodiments of the invention could be configured to ensure that sensitive subject data (which can be predefined and embedded as such in the original dataset or user defined) may be suppressed during the k-anonymisation process, irrespective of the calculated risk thresholds or associated k-block parameters.

1. A computer-implemented method for simulating a data security attack in respect of a specified k-anonymised database derived by a k-anonymisation process using a k-block array having an index representative of equivalence class sizes and populated with elements representative of respective numbers of each said equivalence class size in said k-anonymised database, said k-anonymised database comprising a plurality of subject records, subsets of said subject records being associated with respective subjects and each subject record comprising data representative of a respective subject characteristic, the method comprising:
receiving, as inputs, data representative of the size (D) of said specified database, the size (L) of a hypothetical data leak in respect of said k-anonymised database, and a hypothetical number (n) of subjects to be re-identified by said data security attack;
calculating a total probability P(I_{1 to n}) that n subjects are re-identified from a said data leak by:
for each of a plurality (k) of equivalence class sizes associated with said k-anonymisation:
determining a first term comprising a probability that a first subject A is in said leak;
determining a second term comprising a probability that said first subject A is in said respective equivalence class;
utilising said first and second terms to, for each j other subject in said respective equivalence class, where j ranges from 0 to k_{A}−1:
determine a probability that said j other subjects are in said data leak;
calculate a probability of re-identification of a respective subject given that said subject j and j−1 other subjects are also in said data leak; and
remove said respective subject j from said dataset
and data leak and recursively re-identify the next subject;
and
outputting the total probability, or risk, of such a data attack representative of the likelihood of said data security attack.

2. A computer-implemented method according to claim 1, wherein the size of said database comprises a number (D) of subjects to which said subject records relate.

3. A computer-implemented method according to claim 1 or claim 2, wherein the size of the data leak comprises a number of leaked subject records (L).

4. A computer-implemented method according to any of claims 1 to 3, wherein the total probability P(_{I1 to n}) that a subject (A) is re-identified from a said leak may be calculated by, recursively for each subject and for each of a plurality of equivalence class sizes associated with said k-anonymisation, using an algorithm characterised as,
$$term 1 \times term 2 \times \frac{term 3 \times term 4}{term 5} \times term 6$$
wherein term1 represents a probability of re-identifying said respective subject A and j other subjects in a respective equivalence class in said leak,
term2 corresponds to said first term,
term3 represents the total number of ways the remaining spaces in the leaked data set can be chosen given that A and j other subjects are in the leaked data set,
term4 represents the total number of ways the leaked data set can be filled given that A is already part of the leaked data set,
term5 represents a total number leaked subject records after the removal of said respective subject A and the other j equivalent subjects from the respective equivalence class,
term6 corresponds to said second term.

5. A computer-implemented method according to claim 4, wherein:
$$term 1 = \frac{1}{j + 1} ; term 2 = \frac{L}{D} ;$$
$$\frac{term 3 * term 4}{term 5} = \frac{( \begin{matrix}k - 1 \\ j\end{matrix} ) ( \begin{matrix}D - k \\ L - ( j + 1 )\end{matrix} )}{( \begin{matrix}D - 1 \\ L - 1\end{matrix} )} ;$$
$$term 6 = \frac{number of subjects in k \text{-} blocks of size k}{total number of subjects}$$

6. A computer-implemented method according to any of the preceding claims, wherein said k-block array is populated with a plurality of distinct minimum equivalence class sizes and a respective risk value is output for each of said equivalence class sizes.

7. A computer-implemented method according to claim 6, further comprising selecting a minimum equivalence class size for a said k-anonymisation process to correspond to a selected risk value.

8. A computer-implemented method according to any of the preceding claims, comprising calculating said risk value for a plurality of distinct values of size (D), size (L) of a hypothetical data leak in respect of said k-anonymised database, and/or a hypothetical number (n) of subjects to be re-identified by said data security attack, and outputting data representative of said respective risk values.

9. A computer-implemented apparatus for use in verifying and/or designing a k-anonymised database, the apparatus being configured to simulate a data security attack in respect of a specified k-anonymised database derived by a k-anonymisation process using a k-block array having an index representative of equivalence class sizes and populated with elements representative of respective numbers of each said equivalence class size in said k-anonymised database, said k-anonymised database comprising a plurality of subject records, subsets of said subject records being associated with respective subjects and each subject record comprising data representative of a respective subject characteristic, the apparatus comprising:
an interface for receiving, as inputs, data representative of the size (D) of said specified database, the size (L) of a hypothetical data leak in respect of said k-anonymised database, and a hypothetical number (n) of subjects to be re-identified by said data security attack;
a risk assessment module comprising a processor for receiving said inputs and calculating a total probability P(I_{1 to n}) that n subjects are re-identified from a said data leak by:
for each of a plurality of equivalence class sizes k associated with said k-anonymisation:
determining a first term comprising a probability that a first subject A is in said leak;
determining a second term comprising a probability that said subject A is in said respective equivalence class k_{A};
utilising said first and second terms to, for each j other subject in said respective equivalence class, where j ranges from 0 to k_{A}−1:
determine a probability that said j other subjects are in said data leak;
calculate a probability of re-identification of a respective subject given that said subject and j−1 other subjects are also in said data leak; and
remove said respective subject from said dataset and data leak and recursively re-identify the next subject;
and
outputting, via said interface, a risk value, equal to the said total probability, representative of the likelihood of said data security attack; such that the risk value can be assessed against a predetermined risk threshold to verify said k-anonymised database or enable parameters of said k-anonymisation process to be changed in order to generate a new k-anonymised database having a desired risk threshold.

10. A computer-implemented apparatus according to claim 9, communicably coupled to a k-anonymisation module, and configured to input to said k-anonymisation module a minimum equivalence class value corresponding to a selected risk value.

11. A computer-implemented method for generating a k-anonymised database characterised by a k-block array having an index representative of equivalence class sizes and populated with elements representative of respective numbers of each said equivalence class size, the method comprising:
performing a first k-anonymisation process using first k-anonymisation parameters in respect of an original database to generate a first k-anonymised database characterised by a first minimum equivalence class size;
using a method according to any of claims 1 to 8 to simulate a data security attack in respect of said first k-anonymised database to determine an associated risk value;
comparing said risk value with a predetermined risk threshold and, if said risk value is greater than said predetermined risk threshold, performing a second k-anonymisation process, using second set of k-anonymisation parameters, in respect of said original database to generate a second k-anonymised database characterised by a second minimum equivalence class size greater than said first minimum equivalence class size.

12. A computer-implemented method for generating a k-anonymised database, comprising a selecting a predetermined risk threshold, performing the method of any of claims 1 to 8 iteratively for varying equivalence class sizes until an optimum minimum k-block size to meet said predetermined risk threshold is met.

13. A computer-implemented method for generating a k-anonymised database, comprising selecting a predetermined risk threshold, performing the method of any of claims 1 to 8 multiple times for respective multiple minimum equivalence class sizes, and selecting a minimum equivalence class size from the multiple respective outputs to most closely match the selected predetermined risk threshold.

14. A computer-implemented method according to claim 13, wherein said multiple outputs are in graphical form so as to display the effect on the risk value for different values of minimum equivalence class size.

15. A computer implemented method of generating, for a biomedical research activity, a k-anonymised database derived from an Electronic Health Record database acquired by a healthcare provider comprising a plurality of clinical files associated with a respective plurality of patients, each clinical file comprising a plurality of records pertaining to a respective patient, the method comprising:
selecting or generating a maximum risk threshold comprising or associated with a maximum total probability P(I_{1 to n}) that a patient (A) is re-identified from a predefined data leak in respect of a said k-anonymised database;
defining a first minimum equivalence class size;
performing a first k-anonymisation process in respect of said Electronic Health Record database to derive a first k-anonymised database characterised by a first k-block array having an array index representative of a plurality of equivalence class sizes equal to or greater than said first minimum equivalence class size;
using a method according to any of claims 1 to 8 to simulate a data security attack in respect of said first k-anonymised database to obtain a first risk value associated with said first k-anonymised database;
comparing said first risk value with a predetermined risk value and, if said first risk value is greater than said predetermined risk threshold, selecting a second minimum equivalence class size greater than said first minimum equivalence class size, and performing a second k-anonymisation process in respect of said Electronic Health Record database to derive a second k-anonymised database characterised by a second k-block array having an array index representative of a plurality of equivalence class sizes equal to or greater than said second minimum equivalence class size.
